(19) United States
(12) Patent Application Publication
(10) Pub. No.: US 2025/0311067 A1
(43) Pub. Date: Oct. 2, 2025

(54) METHOD FOR DISPLAYING COOKING INFORMATION, AND INDUCTION HEATING DEVICE USING SAME

(71) Applicant: SAMSUNG ELECTRONICS CO., LTD., Suwon-si (KR)

(72) Inventors: Seokjung YOON, Suwon-si (KR); Elmurod TALIPOV, Suwon-si (KR)

(73) Assignee: SAMSUNG ELECTRONICS CO., LTD., Suwon-si (KR)

(21) Appl. No.: 19/237,942

(22) Filed: Jun. 13, 2025

Related U.S. Application Data
(63) Continuation of application No. PCT/KR2023/020303, filed on Dec. 11, 2023.

(30) Foreign Application Priority Data
Dec. 15, 2022 (KR) 10-2022-0176247

(51) Int. Cl. H05B 6/12; H04N 9/31; H05B 6/06

(52) U.S. Cl. CPC H05B 6/1218; H05B 6/065; H04N 9/3161; H05B 2213/03; H05B 2213/05

(57) ABSTRACT

A method of displaying cooking information, and an induction heating device displaying cooking information. The induction heating device includes an induction heating module, an image projector configured to project an image, at least one memory to store one or more instructions, and at least one processor. The at least one processor executes the one or more instructions stored in the memory to control the image projector to project, onto a first cooking container placed on a first burner among a plurality of burners, a first image set corresponding to the first burner, and control the image projector to project, onto the first cooking container placed on the first burner, a second image set corresponding to a second burner together with the first image set, based on a second cooking container being placed on the second burner among the plurality of burners and inductively heated by the induction heating module.

### CROSS-REFERENCE TO RELATED APPLICATION(S)

This application is a continuation application, claiming priority under § 111(a), of International Application No. PCT/KR2023/020303, filed on Dec. 11, 2023, which is based on and claims the benefit of Korean Patent Application No.: 10-2022-0176247, filed Dec. 15, 2022, in the Korean Intellectual Property Office, the disclosures of which are incorporated by reference herein in their entireties.

### TECHNICAL FIELD

The present disclosure relates to an induction heating device displaying cooking information, a method of controlling the induction heating device, and a computer-readable recording medium storing a computer program performing the method of controlling the induction heating device.

### BACKGROUND ART

An induction heating device is a cooking appliance that heats food by using the principle of induction heating. The induction heating device includes tempered heat-resistant glass on which a cooking container is placed, and a transmitting coil that generates a magnetic field when a current is applied below the tempered heat-resistant glass.

As a current is applied to the transmitting coil, a magnetic field is generated, and the generated magnetic field induces an eddy current to the cooking container including a conductive material. Heat is generated in the cooking container by the collision between the eddy current induced to the cooking container and the resistance of the cooking container.

Such an induction heating device has advantages of being capable of rapid heating, no generation of harmful gases, and no risk of fire, as compared with gas ranges that burn fossil fuels, such as gas or oil, to heat a cooking container through the combustion heat.

### DISCLOSURE OF INVENTION

### Solution to Problem

An aspect of an embodiment of the present disclosure may provide an induction heating device including an induction heating module, an image projector configured to project an image, at least one memory storing one or more instructions, and at least one processor, and the at least one processor is configured to execute the one or more instructions stored in the at least one memory control the image projector to project, onto a first cooking container placed on a first burner among a plurality of burners, a first image set corresponding to the first burner, and control the image projector to project, onto the first cooking container placed on the first burner, a second image set corresponding to a second burner together with the first image set, based on a second cooking container being placed on the second burner among the plurality of burners and inductively heated by the induction heating module.

An aspect of an embodiment of the present disclosure may provide a cooking information display method including projecting, onto a first cooking container placed on a first burner among a plurality of burners, a first image set corresponding to the first burner, and projecting, onto the first cooking container placed on the first burner, a second image set corresponding to a second burner together with the first image set, based on a second cooking container being placed on the second burner among the plurality of burners and inductively heated.

An aspect of an embodiment of the present disclosure may provide a non-transitory computer-readable recording medium having recorded thereon a program, which, when executed by a computer, performs the cooking information display method on a computer.

### BRIEF DESCRIPTION OF DRAWINGS

FIG. 1 shows a method by which an induction heating device provides cooking information, according to an embodiment of the present disclosure.

FIG. 2 shows a block diagram of an induction heating device according to an embodiment of the present disclosure.

FIG. 3 shows a flowchart illustrating a method by which an induction heating device provides cooking information, according to an embodiment of the present disclosure.

FIG. 4 shows a method by which an induction heating device projects cooking information images, according to an embodiment of the present disclosure.

FIG. 5 shows a method by which an induction heating device separately displays a cooking information image of a front burner and a cooking information image of a rear burner, according to an embodiment of the present disclosure.

FIG. 6 shows a method by which an induction heating device determines whether two cooking containers are placed front-to-back on a plurality of burners, according to an embodiment of the present disclosure.

FIG. 7 shows a flowchart illustrating a method by which an induction heating device determines whether two cooking containers are placed front-to-back on flex burners, according to an embodiment of the present disclosure.

FIG. 8 shows a method by which an induction heating device determines whether two cooking containers are placed front-to-back on flex burners, according to an embodiment of the present disclosure.

FIG. 9 shows a method by which an induction heating device moves a cooking information image according to a position of a user, according to an embodiment of the present disclosure.

FIG. 10 shows a method by which an induction heating device projects a cooking information image onto a cooking container, according to an embodiment of the present disclosure.

FIG. 11 shows a method by which an induction heating device projects a cooking information image, according to an embodiment of the present disclosure.

FIG. 12 shows a method by which an induction heating device projects a recipe information image, according to an embodiment of the present disclosure.

FIG. 13 shows a method by which an induction heating device projects cooking information corresponding to burners onto a cooking container, according to an embodiment of the present disclosure.

FIGS. 14A and 14B show a method by which an induction heating device displays cooking information images by using a laser projector within a hood, according to an embodiment of the present disclosure.

FIG. 15 shows a method by which an induction heating device displays cooking information selected by a user, according to an embodiment of the present disclosure.

FIG. 16 shows a block diagram of an induction heating device according to an embodiment of the present disclosure.

### MODE FOR THE INVENTION

In the present disclosure, the expression “at least one of a, b, or c” may refer to “a,” “b,” “c,” “a and b,” “a and c,” “b and c,” “all of a, b, and c,” or variations thereof.

Hereinafter, embodiments of the present disclosure are described in detail with reference to accompanying drawings so that a person having ordinary skill in the art to which the present disclosure pertains may easily implement the present disclosure. However, the present disclosure may be implemented in many different forms and is not limited to the embodiments described herein. In addition, parts that are not related to the explanation are omitted to clearly explain the present disclosure, and similar parts are given similar reference numerals throughout the specification.

Terms used in the present disclosure are described as currently used general terms in consideration of the functions mentioned in the present disclosure, but these may mean various other terms depending on the intention of a technician engaged in the corresponding field, precedents, the emergence of new technologies, or the like. Accordingly, the terms used in the present disclosure should not be interpreted solely based on the names of the terms, but should be interpreted based on the meanings of the terms and the overall contents of the present disclosure.

In addition, terms, such as first and second, may be used to describe various components, but the components should not be limited by these terms. These terms are used to distinguish one component from another.

In addition, the terms used in the present disclosure are for the purpose of describing particular embodiments only and are not intended to limit the present disclosure. Unless the context clearly indicates otherwise, singular expressions include plural meanings. In addition, throughout the specification, when a part is said to be ‘connected’ to another part, this includes not only a case of ‘direct connection’, but also a case where the parts are ‘electrically connected’ to each other with another element therebetween. Also, when it is said that a part ‘includes’ a component, this means that the part may further include other components instead of excluding other components, unless otherwise specifically stated.

Phrases, such as ‘in some embodiments’ or ‘in an embodiment’, stated in various places throughout the specification are not necessarily all referring to the same embodiment.

Embodiments of the present disclosure are to provide an induction heating device providing cooking information and a control method of the induction heating device.

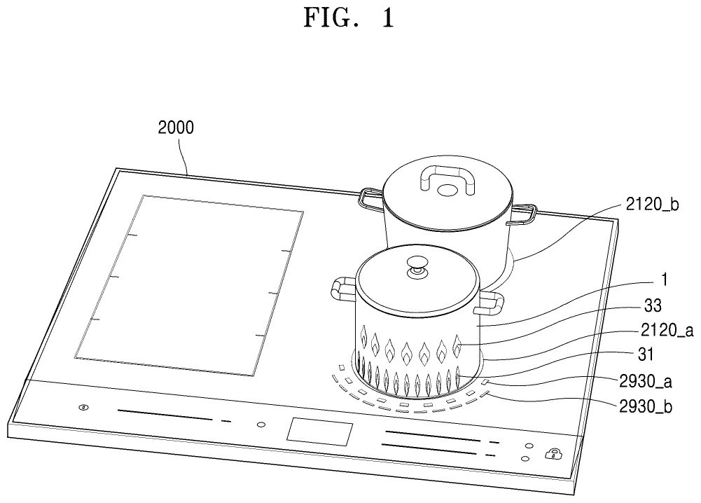

FIG. 1 shows a method by which an induction heating device provides cooking information, according to an embodiment of the present disclosure.

Referring to FIG. 1, an induction heating device 2000 may display cooking information of a burner on a cooking container placed on the burner. Also, the induction heating device 2000 may display cooking information of an adjacent burner on the cooking container placed on the burner.

The induction heating device 2000 may include an image projector (not shown) that projects an image onto a cooking container.

The induction heating device 2000 may display a cooking information image representing cooking information through the image projector (not shown). The cooking information may include a heating level, a cumulative cooking time, a cooking container temperature, recipe information, or the like, but is not limited thereto.

As shown in FIG. 1, the induction heating device 2000 may project, onto a first cooking container 1, a flame image 31 indicating a heating level of a first burner 2120_a. For example, the induction heating device 2000 may include a plurality of first light-emitting diodes (LED) within the induction heating device 2000. Light output by one first LED may be projected onto the first cooking container 1 through one first slit 2930_a to generate one first flame image 31 on the first cooking container 1. The induction heating device 2000 may display the heating level of the first burner 2120_a by varying the size or color of the first flame image 31.

Also, the induction heating device 2000 may display cooking information of an adjacent burner on a cooking container placed on one burner. As shown in FIG. 1, the induction heating device 2000 may display, on the first cooking container 1 placed on the first burner 2120_a, cooking information of a second burner 2120_bpositioned behind the first burner 2120_a.

For example, the induction heating device 2000 may include, in front of the first burner 2120_a, a plurality of second LEDs for the second burner 2120_b, which are separate from the plurality of first LEDs dedicated to the first burner 2120_a. Light output by one second LED may be projected onto the first cooking container 1 through one second slit 2930_bto generate one second flame image 33 on the first cooking container 1.

Because the induction heating device 2000 does not generate a flame when heating a cooking container, it may be difficult for a user to intuitively recognize a heating status of the cooking container when the user is far away from the induction heating device 2000. According to an embodiment of the present disclosure, as a heating level is displayed on a cooking container, the user may recognize the heating status of the cooking container even when being far away from the induction heating device 2000.

In addition, even when heating levels of respective cooking containers are displayed when a plurality of cooking containers are placed on a plurality of burners, it may be difficult to recognize the heating status of a cooking container placed behind when the plurality of cooking containers are placed overlapping in a sight direction of the user. According to an embodiment of the present disclosure, as the heating status of the cooking container placed behind is displayed on a cooking container placed in front, the heating status of the cooking container placed behind may be recognized even when the cooking containers are placed overlapping each other.

According to an embodiment, the induction heating device 2000 may project a first cooking information image corresponding to a front burner together with a second cooking information image corresponding to a rear burner onto a cooking container placed on the front burner, based on identifying that cooking containers are respectively placed on the rear burner and the front burner and the rear burner is performing induction heating.

In this case, the first cooking information image may include a plurality of first flame images indicating that the front burner is performing induction heating, and the second cooking information image may include a plurality of second flame images indicating that the rear burner is performing induction heating.

Also, according to an embodiment, the induction heating device 2000 may display separately a flame image of the front burner and a flame image of the rear burner by projecting a flame image having at least one different color and size from the first flame image as a second flame image.

In addition, according to an embodiment, the induction heating device 2000 may store identification information for each of a plurality of burners and determine whether cooking containers are placed front-to-back based on the identification information of burners on which the cooking containers are placed.

Also, according to an embodiment, the induction heating device 2000 may identify whether cooking containers are placed front-to-back based on at least one of current values and temperature values, which are detected at a plurality of coordinate points within a flex burner area.

In addition, according to an embodiment, the induction heating device 2000 may identify a position of the user based on the induction heating device 2000 and move the position of a cooking information image displayed on a cooking container according to the identified position of the user.

Also, according to an embodiment, the induction heating device 2000 may project a cooking information image onto an upper surface of a cooking container placed on a burner via a laser within a hood device positioned on the induction heating device 2000 when the user is positioned within a reference distance from the induction heating device 2000.

In addition, according to an embodiment, the induction heating device 2000 may display a cooking information image indicating a current temperature of a burner on a cooking container placed on the burner.

Also, according to an embodiment, the induction heating device 2000 may display a cooking information image indicating a cumulative cooking time of a burner on a cooking container placed on the burner.

In addition, according to an embodiment, the induction heating device 2000 may display a numeric image indicating a heating level of a burner on a cooking container placed on the burner.

Also, according to an embodiment, the induction heating device 2000 may receive a user input for selecting cooking information to be displayed on a cooking container from among a plurality of pieces of cooking information related to cooking. In addition, the induction heating device 2000 may display a cooking information image indicating the selected cooking information on a cooking container.

Also, according to an embodiment, some of the plurality of burners may not be equipped with a dedicated image projector. The induction heating device 2000 may display, on a cooking container, cooking information of a burner that is not equipped with a dedicated image projector.

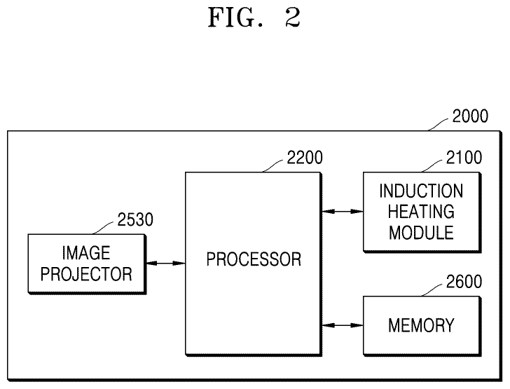

FIG. 2 shows a block diagram of an induction heating device according to an embodiment of the present disclosure.

Referring to FIG. 2, the induction heating device 2000 may include an induction heating module 2100, a processor 2200, a memory 2600, and an image projector 2530.

The induction heating module 2100 may include a heat source for heating food. For example, the induction heating module 2100 may include a transmitting coil (not shown), and the transmitting coil (not shown) may generate a magnetic field for heating a cooking container (not shown). For example, when a driving current is supplied to the transmitting coil (not shown), a magnetic field may be induced around the transmitting coil (not shown). When a current of which the magnitude and direction change over time, that is, an alternating current, is supplied to the transmitting coil (not shown), a magnetic field of which the magnitude and direction change over time may be induced around the transmitting coil (not shown). A magnetic field around the transmitting coil (not shown) may pass through an upper plate including tempered glass and reach a cooking container (not shown) placed on the upper plate. Due to the magnetic field of which the magnitude and direction change over time, an eddy current that rotates around the magnetic field may be generated in the cooking container (not shown), and electrical resistance heat may occur in the cooking container (not shown) due to the eddy current. The electrical resistance heat is the heat generated in a resistor when current flows through the resistor, which is referred to as Joule heat. The cooking container (not shown) is heated by the electrical resistance heat, and contents within the cooking container (not shown) may be heated.

The image projector 2530 may project a cooking information image onto a cooking container.

According to an embodiment, the image projector 2530 may include a light source (not shown). The light source (not shown) may include an LED, a laser, and a lamp, but is not limited thereto. In addition, according to an embodiment, the image projector 2530 may include a convex lens (not shown) together with the light source (not shown). Also, according to an embodiment, when a cooking information image is a virtual moving flame image, the image projector 2530 may include a light source (not shown), a convex lens (not shown), an air injection unit (not shown) and an induction member (not shown).

In addition, according to an embodiment, the image projector 2530 may include a liquid crystal display (LCD) projector, a digital light processing (DLP) projector, an LED projector, a liquid crystal on silicon (LCoS) projector, and a laser projector, but is not limited thereto.

The memory 2600 stores various pieces of information, data, instructions, programs, or programs required for an operation of the induction heating device 2000. For example, the memory 2600 may store identification information of a burner. In addition, the memory 2600 may store recipe information received from a server. The memory 2600 may include at least one volatile memory or non-volatile memory, or a combination thereof.

The processor 2200 may typically control the overall operation of the induction heating device 2000. The processor 2200 may control the induction heating module 2100, a cooking container detection sensor, and the image projector 2530 by executing programs stored in the memory 2600.

The processor 2200 may project, through the image projector 2530, a cooking information image corresponding to a front burner onto a cooking container placed on the front burner among a plurality of burners.

Also, the processor 2200 may project a first cooking information image together with a second cooking information image corresponding to a rear burner through the image projector 2530, based on a second cooking container, which is placed on the rear burner corresponding to the front burner, being inductively heated by the induction heating module 2100.

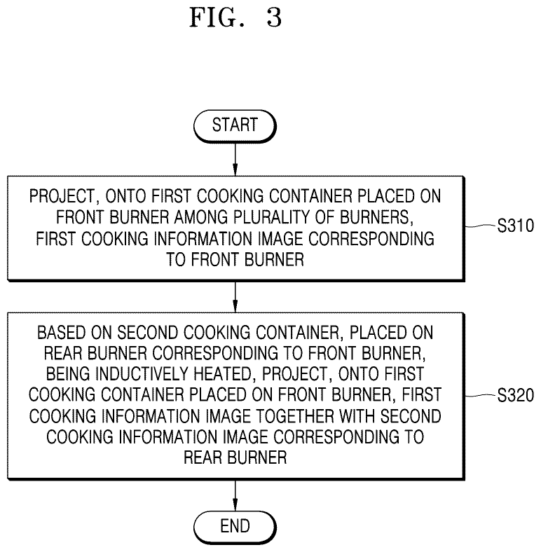

FIG. 3 shows a flowchart illustrating a method by which an induction heating device provides cooking information, according to an embodiment of the present disclosure.

In operation S310, the induction heating device 2000 may project a first cooking information image corresponding to a front burner onto a first cooking container placed on the front burner among a plurality of burners.

The induction heating device 2000 may project, through an image projector, a cooking information image corresponding to the front burner onto the cooking container placed on the front burner among the plurality of burners.

The cooking information image may include at least one of an image indicating a current temperature of a burner, an image indicating a cumulative cooking time of a burner, an image indicating a heating level of a burner, and an image indicating recipe information corresponding to a burner.

The image indicating the heating level of the burner may include, for example, a plurality of flame images or a numeric image indicating a heating level.

According to an embodiment, the induction heating device 2000 may determine image data for a cooking information image indicating cooking information of a burner. In addition, the induction heating device 2000 may input determined image data into an image projector and control the image projector so that a cooking information image is projected by the image projector. In this case, the image data may be image data indicating numbers or image data indicating characters, but is not limited thereto.

The induction heating device 2000 may alternatively project only cooking information selected by the user from among a plurality of pieces of cooking information as a cooking information image.

In operation S320, the induction heating device 2000 may project, onto the first cooking container placed on the front burner, the first cooking information image together with a second cooking information image corresponding to a rear burner, based on a second cooking container, which is placed on the rear burner corresponding to the front burner, being inductively heated.

The induction heating device 2000 may detect that the second cooking container is placed on the rear burner corresponding to the front burner. For example, the induction heating device 2000 may detect, through a cooking container detection sensor, that the second cooking container is placed on the rear burner corresponding to the front burner. In addition, the induction heating device 2000 may detect, through the cooking container detection sensor, that the second cooking container placed on the rear burner has been lifted.

The induction heating device 2000 may receive a user input to inductively heat the second cooking container placed on the rear burner. For example, the induction heating device 2000 may receive a user input of selecting a heating level for the rear burner.

The induction heating device 2000 may project, onto the first cooking container placed on the front burner, the first cooking information image together with the second cooking information image corresponding to the rear burner.

Based on that the induction heating device 2000 receives a user input for inductively heating the second cooking container and detects that the second cooking container is placed on the rear burner, the induction heating device 2000 may project, onto the first cooking container placed on the front burner, the first cooking information image corresponding to the front burner together with the second cooking information image corresponding to the rear burner.

According to an embodiment, the first cooking information image may be a plurality of first flame images indicating that the front burner is performing induction heating. Also, the second cooking information image may be a plurality of second flame images indicating that the rear burner is performing induction heating.

In addition, to distinguish between the first cooking information image and the second cooking information image, the colors or numbers of the first flame images and the plurality of second flame images may be different from each other.

According to an embodiment, a plurality of burners may include a flex burner where only a partial area of a burner area may be inductively heated. Also, the induction heating device 2000 may identify coordinate values of an area where at least one cooking container is placed among an area of the flex burner, based on at least one of current values and temperatures, which are detected at a plurality of coordinate points within the area of the flex burner. In addition, the induction heating device 2000 may identify whether at least one cooking container is placed front-to-back, based on the identified coordinate values. Also, the induction heating device 2000 may project, onto a front cooking container placed in front, a cooking information image corresponding to the front cooking container together with a cooking information image corresponding to a cooking container placed behind, based on at least one cooking container being placed front-to-back.

According to an embodiment, the induction heating device 2000 may identify a position of the user through a position sensor. Also, the induction heating device 2000 may move the positions of the first cooking information image and the second cooking information image, which are displayed on the first cooking container, according to the identified position of the user.

According to an embodiment, the induction heating device 2000 may identify whether the user is positioned within a reference distance from the induction heating device 2000 through a human body detection sensor. In addition, the induction heating device 2000 may project the first cooking information image onto an upper surface of the first cooking container placed on the front burner and the second cooking information image onto an upper surface of the second cooking container placed on the rear burner by controlling a laser of a hood device positioned above the induction heating device 2000 based on the position of the user being within the reference distance from the induction heating device 2000.

According to an embodiment, a plurality of burners may include a burner that is not equipped with a dedicated image projector. Also, the induction heating device 2000 may project, onto the first cooking container placed on the front burner through an image projector, a cooking information image corresponding to a burner that is not equipped with a dedicated image projector.

According to an embodiment, both the front burner and the rear burner may be equipped with dedicated image projectors. In this case, the induction heating device 2000 may stop an operation of the dedicated image projector of the rear burner, which is being driven, when the first cooking container is placed on the front burner after the second cooking container is placed on the rear burner.

According to an embodiment, as a user input for inductively heating the rear burner is received, regardless of whether a cooking container is placed on the rear burner, the induction heating device 2000 may project a cooking information image corresponding to the rear burner onto a cooking container placed on the front burner.

According to an embodiment, the induction heating device 2000 may project a cooking information image corresponding to the rear burner onto a cooking container placed on the front burner, regardless of whether a cooking container is placed on the rear burner and whether the rear burner is inductively heated.

According to an embodiment, the induction heating device 2000 may not project a cooking information image corresponding to the rear burner onto the first cooking container, based on detection that a cooking container placed on the rear burner has been lifted.

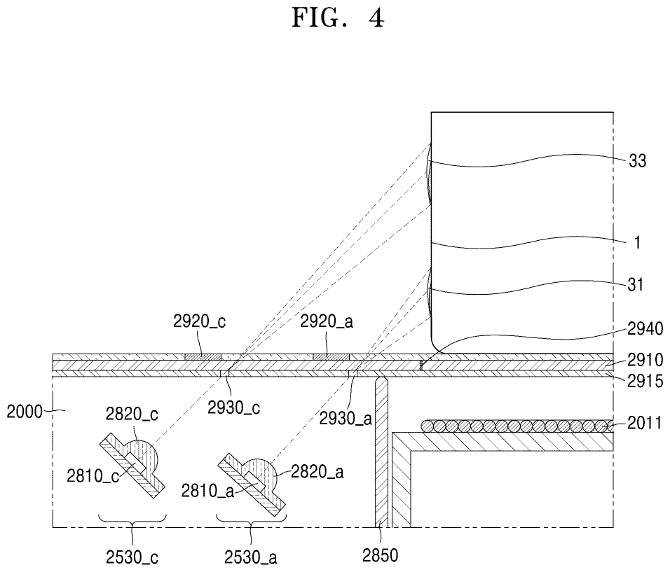

FIG. 4 shows a method by which an induction heating device projects cooking information images, according to an embodiment of the present disclosure.

Referring to FIG. 4, to display a cooking information image of a front burner as well as a cooking information image of a rear burner onto a cooking container 1 placed on the front burner, the induction heating device 2000 may include an image projector for the front burner as well as an image projector for the rear burner below a front surface of the front burner. For example, a first image projector 2530_a and a second image projector 2530_c may be provided below the front surface of the front burner. The induction heating device 2000 may display cooking information of the front burner through the first image projector 2530_a and display cooking information of the rear burner through the second image projector 2530_c.

An image projector 2530_a or 2530_c for a flame image may include at least one LED 2810_a or 2810_b and at least one convex lens 2820_a or 2820_b. The convex lens 2820_a or 2820_b may be positioned above the LED 2810_a or 2810_b to focus light emitted by the LED 2810_a or 2810_b, and may have a hemispherical shape. Light emitted by the LED 2810_a or 2810_b may be focused through the convex lens 2820_a or 2820_b to improve rectilinear property.

Also, the image projector 2530_a or 2530_c may be positioned below a tempered heat-resistant glass 2910. In this case, the image projector 2530_a or 2530_c may be arranged to be inclined at a predetermined angle toward a lower end portion of a side surface of the cooking container 1 so that light emitted by the image projector 2530_a or 2530_c is irradiated to be inclined at the predetermined angle toward the lower end portion of the side surface of the cooking container 1. Also, one image projector 2530_a or 2530_c may project one flame image. In addition, the image projector 2530_a or 2530_c may include, outside a radius of a burner, a plurality of image projectors at regular distances along the radius of the burner.

A light-blocking film 2915 may be attached to a bottom surface of the tempered heat-resistant glass 2910. The light-blocking film 2915 may include an opaque material and block light so that light emitted by the image projector 2530_a or 2530_c does not pass through the tempered heat-resistant glass 2910. The light-blocking film 2915 may be, for example, black. Also, the light-blocking film 2915 may include a slit 2930_a or 2930_c through which light emitted by the image projector 2530_a or 2530_c may pass.

The slit 2930_a or 2930_c may be arranged inside a radius of the image projector 2530_a or 2530_c to allow light emitted by the image projector 2530_a or 2530_c to pass through. Accordingly, light that has passed through the slit 2930_a or 2930_c may pass through the tempered heat-resistant glass 2910 and is refracted and diffused to be displayed as a flame image 31 or 33 at the lower end portion of the side surface of the cooking container 1.

Also, the induction heating device 2000 may include a concealment band 2920_a or 2920_c on the tempered heat-resistant glass 2910 to prevent unnecessary emission of light emitted by the image projector 2530_a or 2530_c and to prevent the user from recognizing the presence of the LED 2810_a or 2810_c.

In addition, a container guiding line 2940 for indicating a proper position of the cooking container 1 may be provided within the tempered heat-resistant glass 2910.

Also, the induction heating device 2000 may include a heat dissipation plate 2850 to prevent heat of a transmitting coil 2011 from affecting the image projector 2530_a or 2530_c.

According to an embodiment, the induction heating device 2000 may adjust the size, color, or degree of movement of a flame image projected onto the cooking container 1 placed on a burner according to a heating level of the burner.

For example, the induction heating device 2000 may include a flow member (not shown) for temporarily blocking light emitted by the image projector 2530_a or 2530_c and an air injection unit (not shown) for moving the flow member (not shown).

The flow member (not shown) may freely flow and shake as a whole by collision with injected air. The flame image 31 or 33 displayed on the cooking container 1 may appear to shake while part of light emitted by the image projector 2530_a or 2530_c is momentarily obscured by the movement of the flow member (not shown). Accordingly, the user may intuitively recognize that the cooking container 1 is being heated through the flame image 31 or 33 that moves similarly to reality.

The induction heating device 2000 may adjust the degree of shaking of the flow member (not shown) by controlling the speed or amount of air injection through the air injection unit (not shown). As the degree of shaking of the flow member (not shown) is adjusted, a degree of blocking of light emitted by the image projector 2530_a or 2530_c may be adjusted, and accordingly, the size or degree of movement of a flame image projected onto the cooking container 1 may be adjusted.

Also, the image projector 2530_a for the front burner and the image projector 2530_c for the rear burner may include LEDs of different colors. For example, the image projector 2530_a for the front burner may include a blue LED, and the image projector 2530_c for the rear burner may include a red LED. Accordingly, a flame image of the front burner and a flame image of the rear burner may be projected onto the cooking container 1 with different colors.

In addition, the number of image projectors 2530_a for the front burner and the number of image projectors 2530_c for the rear burner may differ by more than a standard number. For example, the number of image projectors 2530_a for the front burner may be 10, and the number of image projectors 2530_c for the rear burner may be 5. Accordingly, the number of flame images of the front burner and the number of flame images of the rear burner, which are displayed on the cooking container 1, may be different from each other.

According to an embodiment, a single image projector (not shown) may project a cooking information image 31 for a front burner as well as a cooking information image 33 for a rear burner onto the cooking container 1. For example, the image projector (not shown) may include two LEDs of different colors, and the induction heating device 2000 may project the cooking information image 31 for the front burner as well as the cooking information image 33 for the rear burner onto a cooking container by simultaneously lighting the two LEDs.

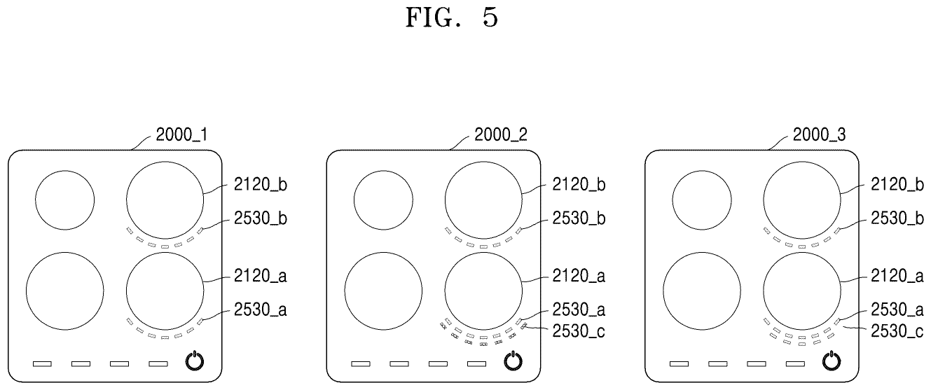

FIG. 5 shows a method by which an induction heating device separately displays a cooking information image of a front burner and a cooking information image of a rear burner, according to an embodiment of the present disclosure.

Referring to FIG. 5, the induction heating device 2000 may display a cooking information image of a front burner and a cooking information image of a rear burner on a cooking container of the front burner with different colors or sizes.

Referring to a first induction heating device 2000_1 of FIG. 5, the induction heating device 2000_1 may include image projectors 2530_a or 2530_b dedicated to respective burners in correspondence to the respective burners 2120_a or 2120_b. In this case, the induction heating device 2000_1 may display only a cooking information image of a front burner 2120_a on a cooking container of the front burner 2120_a and may display only a cooking information image of a rear burner 2120_b on a cooking container of the rear burner 2120_b.

Referring to a second induction heating device 2000_2, the induction heating device 2000_2 may include an image projector 2530_a for the front burner 2120_a together with an image projector 2530_c for the rear burner 2120_b on a front surface of the front burner 2120_a. The induction heating device 2000_2 may display, on a cooking container of the front burner 2120_a, a first cooking information image (for example, a heating level of the front burner 2120_a) having a first color (for example, blue color) through the image projector 2530_a for the front burner 2120_a and a second cooking information image (for example, a heating level of the rear burner 2120_b) having a second color (for example, red color) that is different from the first color through the image projector 2530_c for the rear burner 2120_b.

Accordingly, even when a cooking container placed on the rear burner 2120_b is obscured by a cooking container placed on the front burner 2120_a, the user may know the cooking information of the rear burner 2120_b through the second cooking information image displayed on the front burner 2120_a and may easily distinguish between first cooking information and second cooking information by distinguishing the colors of the first cooking information image corresponding to the front burner 2120_a and the second cooking information image corresponding to the rear burner 2120_b.

Referring to a third induction heating device 2000_3, the induction heating device 2000_3 may include an image projector 2530_a for the front burner 2120_a together with an image projector 2530_x for the rear burner 2120_b on the front surface of the front burner 2120_a. The induction heating device 2000_3 may display, on a cooking container of the front burner 2120_a, a first cooking information image of a first size (for example, 10 flame images) through the image projector 2530_a for the front burner 2120_a and a second cooking information image of a second size (for example, 5 flame images) that is different from the first size through the image projector 2530_c for the rear burner 2120_b.

Accordingly, the user may easily distinguish between first cooking information and second cooking information according to the sizes of the first cooking information image corresponding to the front burner 2120_a and the second cooking information image corresponding to the rear burner 2120_b.

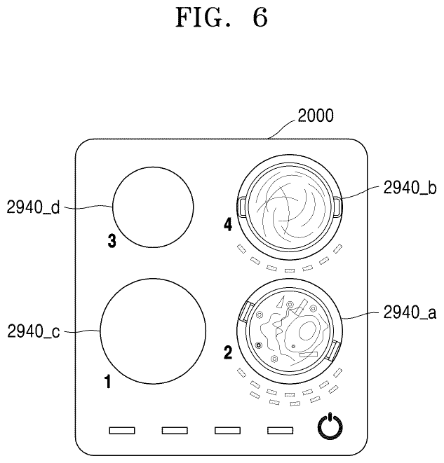

FIG. 6 shows a method by which an induction heating device determines whether two cooking containers are placed front-to-back on a plurality of burners, according to an embodiment of the present disclosure.

Referring to FIG. 6, the induction heating device 2000 may include a plurality of burners, and may store identification information in correspondence to each of the plurality of burners. For example, as shown in FIG. 6, the induction heating device 2000 may store first to fourth identification information in correspondence to respective burners.

The induction heating device 2000 may obtain, through a cooking container detection sensor (not shown), identification information of a burner on which a cooking container is placed. The induction heating device 2000 may determine whether two cooking containers are placed front-to-back, based on the identification information of burners on which the cooking containers are placed.

For example, referring to FIG. 6, when the identification information of burners on which cooking containers are placed is 2 and 4, the induction heating device 2000 may determine that two cooking containers are placed front-to-back on the second and fourth burners.

In addition, the induction heating device 2000 may identify the identification information of a turned-on burner or a heating level corresponding to the burner, based on a user input of selecting the heating level corresponding to the burner.

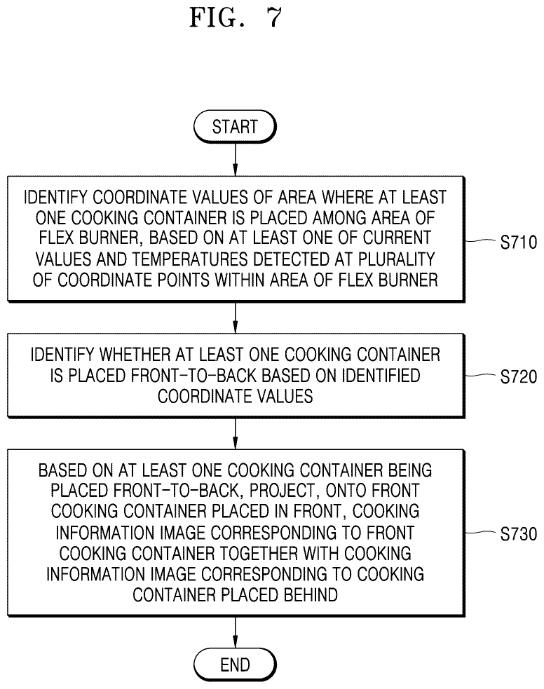

FIG. 7 shows a flowchart illustrating a method by which an induction heating device determines whether two cooking containers are placed front-to-back on flex burners, according to an embodiment of the present disclosure.

In operation S710, the induction heating device 2000 may identify coordinate values of an area where at least one cooking container is placed among an area of the flex burner, based on at least one of current values and temperatures, which are detected at a plurality of coordinate points within the area of the flex burner.

The flex burner is a burner that may inductively heat a plurality of cooking containers regardless of positions where the cooking containers are placed. The flex burner may inductively heat only a partial area among a burner area, based on an area where a cooking container is placed. Accordingly, the flex burner may heat one cooking container having a large size, and may also heat several cooking containers having small sizes.

The induction heating device 2000 may detect current values at a plurality of coordinate points within a flex burner area through a current sensing circuit. Also, the induction heating device 2000 may detect temperatures at a plurality of coordinate points within the flex burner area through a temperature sensor.

The induction heating device 2000 may determine adjacent coordinate values representing similar temperature or current values as one area. Also, the induction heating device 2000 may determine a partial area as an area where a cooking container is placed when the temperature of coordinate values of the partial area is higher than the temperature of coordinate values of a surrounding area.

In operation S720, the induction heating device 2000 may identify whether at least one cooking container is placed front-to-back, based on the identified coordinate values.

For example, the induction heating device 2000 may determine two areas where cooking containers are placed, and may determine that the cooking containers are placed front-to-back in two areas when the x-coordinates of the two areas overlap by a reference range or more and the y-coordinates of the two areas do not overlap each other.

In operation S730, the induction heating device 2000 may project, onto a front cooking container placed in front, a cooking information image corresponding to the front cooking container together with a cooking information image corresponding to a cooking container placed behind, based on at least one cooking container being placed front-to-back.

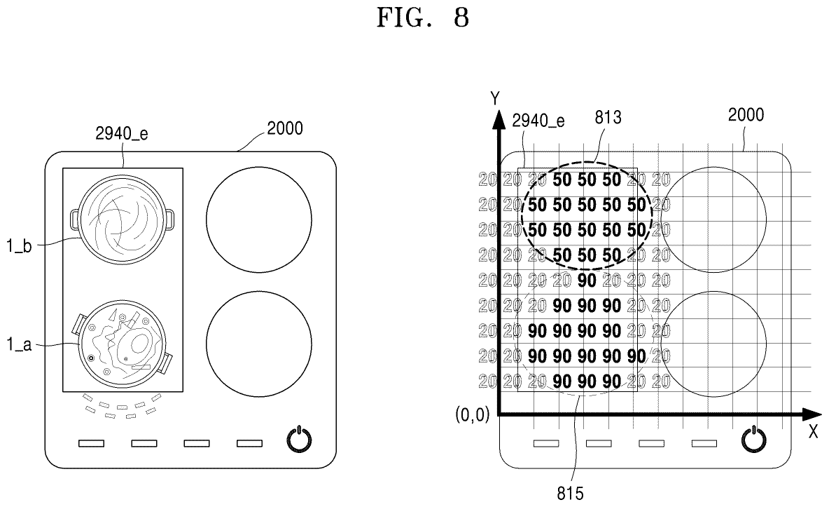

FIG. 8 shows a method by which an induction heating device determines whether two cooking containers are placed front-to-back on flex burners, according to an embodiment of the present disclosure.

Referring to FIG. 8, the induction heating device 2000 may include a flex burner 2940_e in which an entire burner area may be inductively heated or only a partial area of the burner area is inductively heated based on a user input and an area where a cooking container is placed.

The induction heating device 2000 may detect, through a current sensing circuit (not shown) within the induction heating device 2000, current values at a plurality of coordinate points within an area of the flex burner 2940_e. In addition, the induction heating device 2000 may detect, through a temperature sensor (not shown) within the induction heating device 2000, temperatures at a plurality of coordinate points within the area of the flex burner 2940_e.

The induction heating device 2000 may identify coordinate values of an area where a cooking container is placed among the area of the flex burner, based on the current values or temperatures at the plurality of coordinate points within the area of the flex burner 2940_e.

For example, the induction heating device 2000 may determine adjacent coordinate values indicating similar temperatures or current values as one area. In addition, for example, because most of the pans are circular or rectangular, the induction heating device 2000 may determine a circular area or a rectangular area, which indicates similar temperatures or current values, as one area.

The induction heating device 2000 may determine a partial area as an area where a cooking container is placed when the temperature of coordinate values of the partial area is higher than the temperature of coordinate values of a surrounding area. For example, as shown in FIG. 8, the induction heating device 2000 may determine a partial area 813 indicating 50 degrees as an area where a cooking container is placed, and may determine a partial area 815 indicating 90 degrees as an area where another cooking container is placed. Also, the induction heating device 2000 may determine the partial area is being used for cooking when the temperature of coordinate values of the partial area exceeds a critical temperature.

In addition, for example, the induction heating device 2000 may determine the partial area as an area where a cooking container is placed when current values of coordinate values of the partial area are greater than current values of coordinate values of the surrounding area.

The induction heating device 2000 may identify whether two cooking containers are placed front-to-back based on the coordinate values of the areas 813 and 815 where the cooking containers are placed. For example, the induction heating device 2000 may determine two areas 813 and 815 in which cooking containers are placed, and may determine that the cooking containers are placed front-to-back in the two areas 813 and 815 when x coordinates of the two areas 813 and 815 overlap by a reference range or more and the y-coordinates of the two areas 813 and 815 do not overlap each other. In addition, the induction heating device 2000 may determine the area 815 indicating a lower y-coordinate value as a front area and the area 813 indicating a higher y-coordinate value as a rear area, based on the y-coordinate values of the two areas 813 and 815.

Based on determining that cooking containers 1_a and 1_b are placed front-to-back on the flex burner 2940_e, the induction heating device 2000 may project a cooking information image of the front area 815 together with a cooking information image of the rear area 813 onto the cooking container 1_a placed in the front area 815.

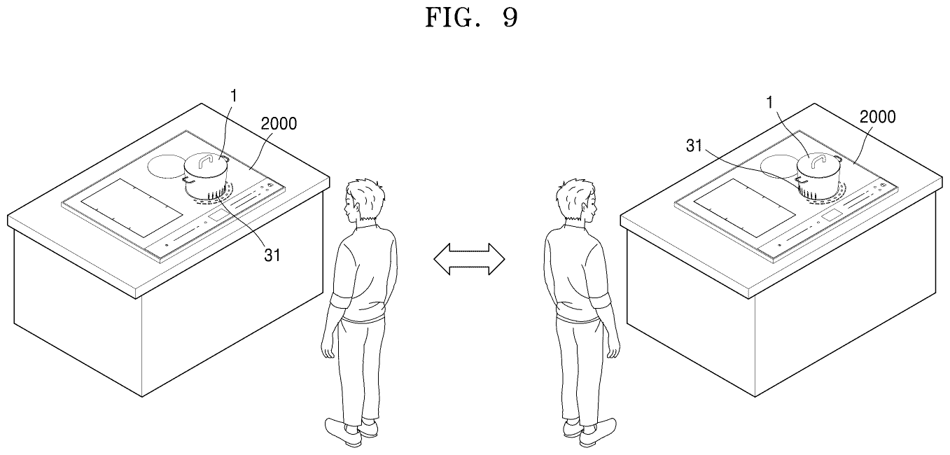

FIG. 9 shows a method by which an induction heating device moves a cooking information image according to a position of a user, according to an embodiment of the present disclosure.

Referring to FIG. 9, the induction heating device 2000 may determine an angle of a user based on the induction heating device 2000 and move a cooking information image based on the determined angle of the user. Also, the induction heating device 2000 may determine a distance from the induction heating device 2000 to the user and change the size of a cooking information image based on the determined distance.

According to an embodiment, the induction heating device 2000 may receive position information of the user from a mobile device (not shown) through short-range wireless communication. Also, the induction heating device 2000 may also receive position information of the user from a wearable device (not shown) of the user through short-range wireless communication. The induction heating device 2000 may determine at least one of an angle and a distance of the user relative to the induction heating device 2000, based on the received position information of the user.

According to an embodiment, the induction heating device 2000 may determine the position of the user based on a sensor value of a position sensor (not shown). The position sensor (not shown) may include an ultrasonic sensor or a camera sensor, but is not limited thereto.

For example, the induction heating device 2000 may sequentially transmit ultrasonic waves over a predetermined angle toward the front and receive reflected waves for the transmitted ultrasonic waves. The induction heating device 2000 may determine an angle and a distance of the user relative to the induction heating device 2000 based on the received reflected waves.

In addition, the induction heating device 2000 may obtain an image of the user through a camera sensor, identify the position of the user within the obtained image of the user, and determine the angle and distance of the user relative to the induction heating device 2000 based on the identified position of the user.

According to an embodiment, the induction heating device 2000 may also receive information about the position of the user from a server.

For example, as a user input of turning on a television (TV) is received, the TV may transmit, to the server, information indicating that the user input of turning on the TV has been received. Also, for example, as a user input of turning on the light of a living room is received, a light controller in the home may transmit, to the server, information indicating that the user input of turning on the light of the living has received. In addition, for example, as a cleaning robot may recognize the user by using a sensor, the cleaning robot may transmit, to the server, information indicating that the user has been recognized together with the position of the cleaning robot.

The server may determine the position of the user based on information received from devices within the home and previously stored position information of the devices within the home. For example, it may be determined that the user is close to the position of the cleaning robot based on the position information of the cleaning robot. Accordingly, the server may transmit information about the position of the cleaning robot based on the position of the induction heating device 2000 to the induction heating device 2000 as position information of the user.

The induction heating device 2000 may determine the angle and distance of the user relative to the induction heating device 2000, based on the received position information of the user.

The induction heating device 2000 may move a cooking information image according to the determined angle of the user.

Referring to the left drawing of FIG. 9, when the user is positioned in front of the induction heating device 2000, the induction heating device 2000 may display a cooking information image 31 at the center of a front surface of the cooking container 1. Referring to the right drawing of FIG. 9, as the user moves from the front to the left side surface of the induction heating device 2000, the induction heating device 2000 may move the cooking information image 31 to the left side surface of the cooking container 1.

Also, the induction heating device 2000 may change the size of a cooking information image according to a determined user distance. For example, the induction heating device 2000 may increase the size of a cooking information image as a distance from the induction heating device 2000 to the user increases.

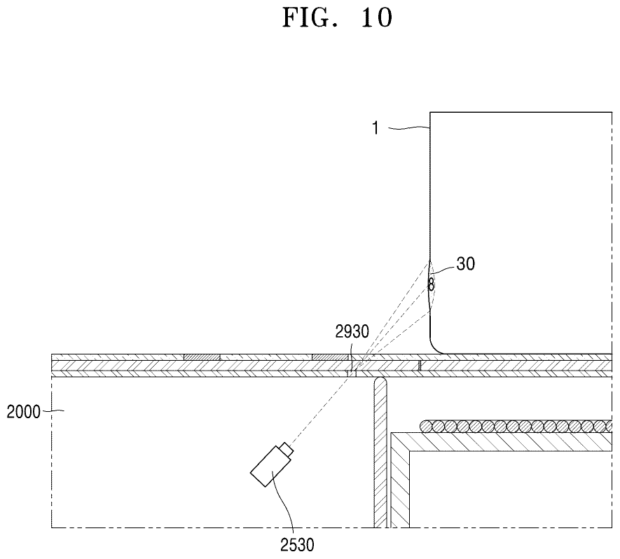

FIG. 10 shows a method by which an induction heating device projects a cooking information image onto a cooking container, according to an embodiment of the present disclosure.

Referring to FIG. 10, the induction heating device 2000 may project a cooking information image onto a cooking container through an image projector 2530. The image projector 2530 may include an LCD projector, a DLP projector, an LED projector, an LCoS projector, and a laser projector, but is not limited thereto.

The image projector 2530 may be arranged to be inclined at a predetermined angle toward a lower end portion of a side surface of the cooking container 1 so that light emitted by the image projector 2530 is irradiated to be inclined at the predetermined angle toward the lower end portion of the side surface of the cooking container 1.

The light emitted by the image projector 2530 may be emitted to the outside of the induction heating device 2000 through a slit 2930 to be projected onto the cooking container 1.

According to an embodiment, one image projector 2530 may be provided below a front surface of a burner in correspondence to one burner.

The induction heating device 2000 may determine cooking information to be projected onto the cooking container 1 placed on a burner. For example, the induction heating device 2000 may determine at least one of a heating level of a burner, a cumulative heating time of a burner, a temperature of a burner, and recipe information corresponding to a burner.

The induction heating device 2000 may determine image data for a cooking information image indicating the cooking information. For example, the induction heating device 2000 may obtain numeric image data corresponding to a heating level of a burner. Also, for example, the induction heating device 2000 may obtain numeric image data corresponding to a cumulative heating time of a burner and graphic image data corresponding to the cumulative heating time. In addition, for example, the induction heating device 2000 may obtain character image data corresponding to recipe information.

The induction heating device 2000 may input the determined image data into an image projector and control the image projector to project a cooking information image corresponding to the input image data onto a cooking container. For example, as shown in FIG. 10, an “8” image 30 indicating a heating level of a burner may be projected onto the cooking container 1.

According to an embodiment, the induction heating device 2000 may also project, onto the cooking container 1 through the image projector 2530, one cooking information image including cooking information of not only a burner on which the cooking container 1 is placed but also adjacent burners.

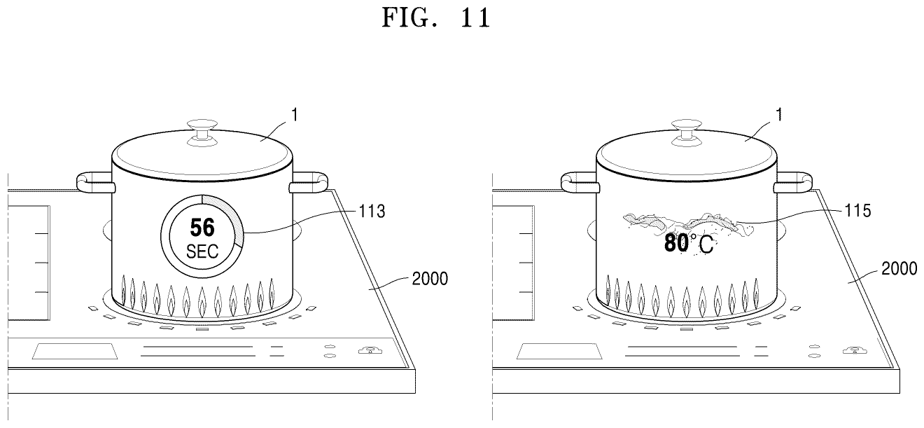

FIG. 11 shows a method by which an induction heating device projects a cooking information image, according to an embodiment of the present disclosure.

Referring to FIG. 11, the induction heating device 2000 may project at least one of a heating level of a burner, a cumulative heating time, and a temperature of a cooking container onto the cooking container.

Referring to the left drawing of FIG. 11, the induction heating device 2000 may project a cumulative heating time of a burner.

The induction heating device 2000 may determine the cumulative heating time of the burner.

For example, the induction heating device 2000 may determine an elapsed time after a user input (for example, a user input of selecting a heating level of 1 or more) for operating the burner is received as a cumulative heating time of the burner. In this case, the induction heating device 2000 may initialize the cumulative heating time of the burner upon receiving a user input (for example, a user input of selecting a heating level to be 0 or turning off the power) for terminating the operation of the burner.

Also, for example, the induction heating device 2000 may determine an operation time of the burner according to a user input after detecting that a cooking container is placed on the burner as a cumulative heating time of the burner. In this case, the induction heating device 2000 may accumulate heating time even when the burner operates again after the operation of the burner has ended. Also, the induction heating device 2000 may initialize the cumulative heating time of the burner upon detecting that the cooking container has been separated from the burner.

Upon the detection of the cumulative heating time, the induction heating device 2000 may obtain numeric image data corresponding to the cumulative heating time of the burner and graphic image data corresponding to the cumulative heating time. In addition, the induction heating device 2000 may input the determined image data into an image projector and control the image projector to project a cumulative heating time image 113 corresponding to the input image data onto the cooking container 1.

Referring to the right drawing of FIG. 11, the induction heating device 2000 may project a temperature of a cooking container onto the cooking container.

The induction heating device 2000 may determine the temperature of a cooking container. For example, the induction heating device 2000 may include a temperature sensor. For example, the temperature sensor (not shown) may be installed near a transmitting coil (not shown) and a steel glass upper plate. The induction heating device 2000 may sense the temperature of an upper plate of a burner through a temperature sensor. Also, the induction heating device 2000 may determine the temperature of the upper plate of the burner as a temperature of a cooking container placed on the burner. Upon the determination of the temperature of the cooking container, the induction heating device 2000 may obtain numeric image data corresponding to the temperature of the cooking container. Also, the induction heating device 2000 may input the determined image data into the image projector and control the image projector to project a temperature image 115 corresponding to the input image data onto the cooking container 1.

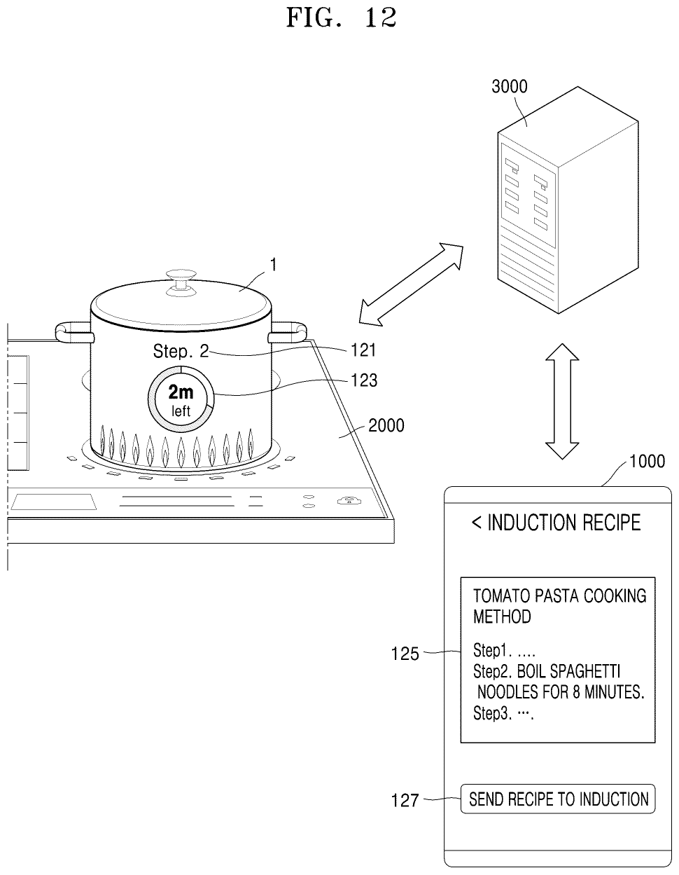

FIG. 12 shows a method by which an induction heating device projects a recipe information image, according to an embodiment of the present disclosure.

Referring to FIG. 12, the induction heating device 2000 may project a recipe information image onto a cooking container.

The induction heating device 2000 may receive, from a server, recipe information of a recipe selected by the user.

A mobile device 1000 may receive recipe information 125 from a server 3000 and display the received recipe information 125. The mobile device 1000 may receive a user input of transmitting a selected recipe to the induction heating device 2000 through a user interface 127. The mobile device 1000 may request the server 3000 to transmit the recipe information 125 of the selected recipe to the induction heating device 2000, based on user account information. The server 3000 may transmit the recipe information 125 of the selected recipe to the induction heating device 2000 corresponding to the user account information.

The induction heating device 2000 may receive a user input of selecting a burner to be cooked according to the received recipe. Also, the induction heating device 2000 may receive a user input of starting cooking according to a recipe.

As cooking according to the recipe has started, the induction heating device 2000 may project an image indicating recipe information onto a cooking container 1 placed on the selected burner. For example, the induction heating device 2000 may project an image 121 indicating a currently in-progress step among steps of the recipe and an image 123 indicating a remaining cooking time of the currently in-progress step.

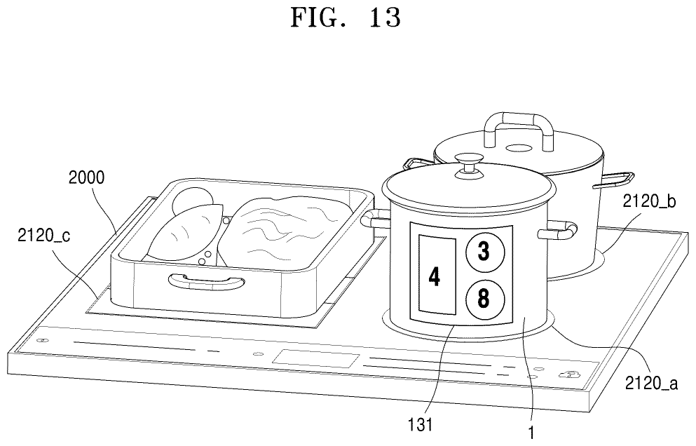

FIG. 13 shows a method by which an induction heating device projects cooking information corresponding to burners onto a cooking container, according to an embodiment of the present disclosure.

Referring to FIG. 13, the induction heating device 2000 may project cooking information images of adjacent burners onto a cooking container placed on a burner. For example, the induction heating device 2000 may display cooking information of a rear burner 2120_b and a side burner 2120_c, which are not equipped with dedicated image projectors, on a cooking container placed on a burner 2120_a equipped with an image projector.

For example, when a heating level of a first burner 2120_a is 8, a heating level of a second burner 2120_b is 3, and a heating level of a third burner 2120_c is 4, the induction heating device 2000 may project an image 131 indicating respective burners and heating levels corresponding to the respective burners onto a cooking container 1 placed on the first burner 2120_a.

According to an embodiment, the induction heating device 2000 may also project an image indicating cooking information of the burners onto a downdraft-type hood or wall surface positioned behind the induction heating device 2000 instead of a cooking container.

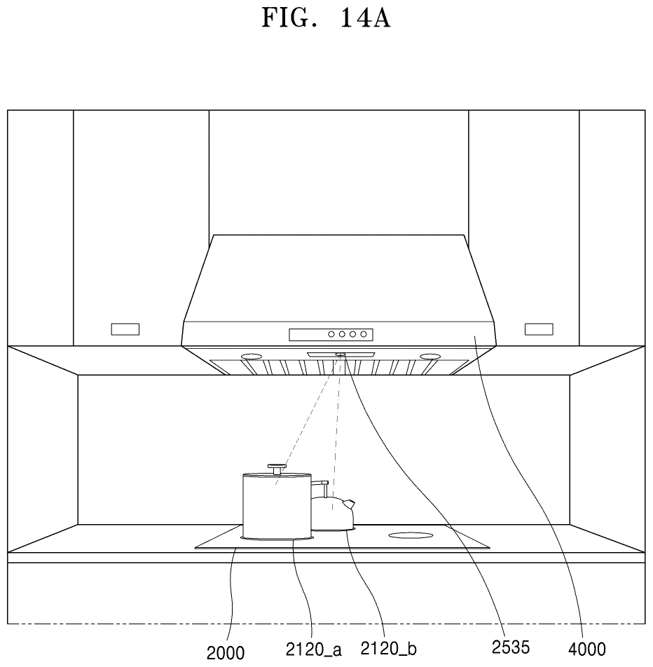

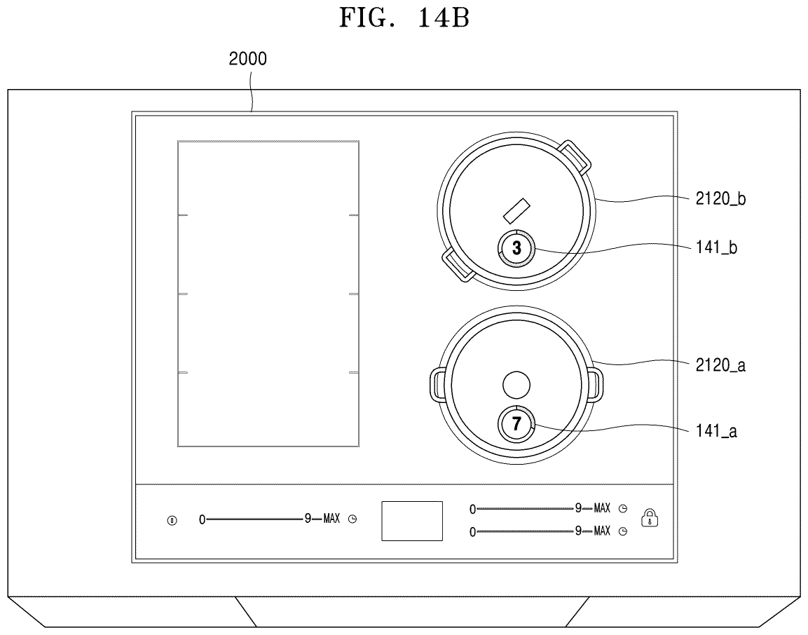

FIGS. 14A and 14B show a method by which an induction heating device displays cooking information images by using a laser projector within a hood, according to an embodiment of the present disclosure.

Referring to FIG. 14A, the induction heating device 2000 may control an image projector within a hood 4000 to project a cooking information image corresponding to a burner onto an upper surface of a cooking container. In this case, the image projector may be a laser projector 2535, but is not limited thereto. The laser projector 2535 may be included within the hood 4000, or may be attached to the hood 4000 as a separate device from the hood 4000.

The induction heating device 2000 may control the laser projector 2535 within the hood 4000 through a short-range wireless communication connection.

According to an embodiment, the induction heating device 2000 may establish a short-range wireless communication connection with the hood 4000. Also, according to an embodiment, the induction heating device 2000 may also establish a short-range wireless communication connection with the laser projector 2535 attached to the hood 4000.

The induction heating device 2000 may transmit control information about the laser projector 2535 to the hood 4000 through the short-range wireless communication connection. The control information about the laser projector 2535 may include image data about a cooking information image and identification information of a burner on which the cooking information image is to be displayed. For example, the control information may include cooking information image data indicating a heating level 7 to be projected onto the first burner 2120_a and cooking information image data indicating a heating level 3 to be projected onto the second burner 2120_b.

According to an embodiment, the induction heating device 2000 may also transmit the control information to the laser projector 2535 attached to the hood 4000 through the short-range wireless communication connection.

According to an embodiment, the induction heating device 2000 may also transmit the control information to the hood 4000 or the laser projector 2535 only when the user is near the induction heating device 2000. To this end, the induction heating device 2000 may include a human body detection sensor. The human body detection sensor may include a passive infrared (PIR) sensor, an ultrasonic motion sensor, and a laser motion sensor, but is not limited thereto.

The induction heating device 2000 may determine whether the user is positioned within a predetermined distance from the induction heating device 2000 through the human body detection sensor. The predetermined distance may be, for example, 30 cm, but is not limited thereto.

Based on determination that the user is positioned within the predetermined distance from the induction heating device 2000, the induction heating device 2000 may transmit the control information to the hood 4000 or the laser projector 2535.

Referring to FIG. 14B, the laser projector 2535 may project a cooking information image onto a burner based on the control information.

For example, the laser projector 2535 may project a cooking information image 141_a indicating a heating level 7 onto the first burner 2120_a and a cooking information image 141_b indicating a heating level 3 onto the second burner 2120_b, based on the control information.

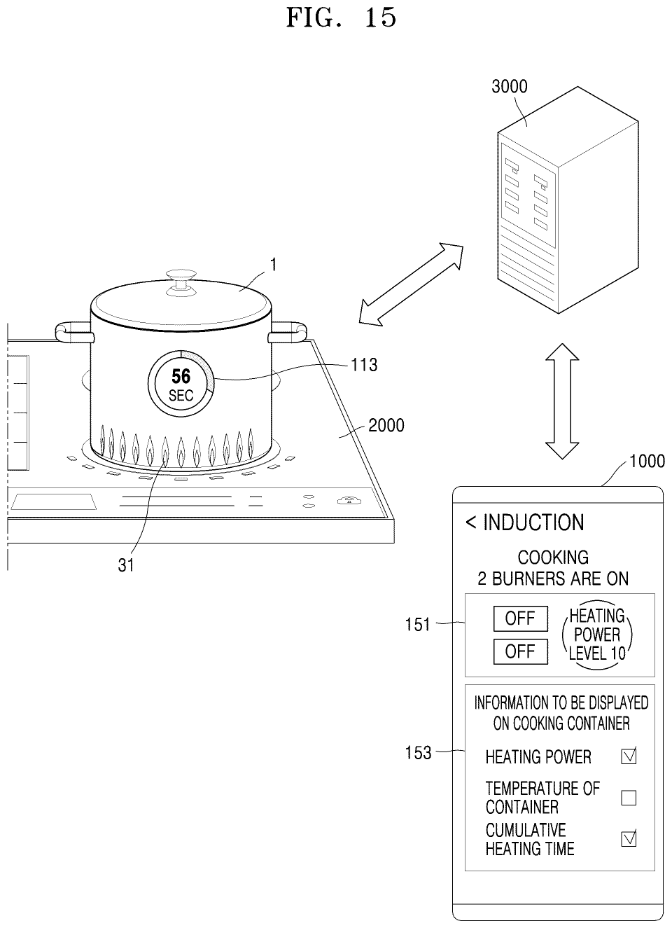

FIG. 15 shows a method by which an induction heating device displays cooking information selected by a user, according to an embodiment of the present disclosure.

Referring to FIG. 15, the induction heating device 2000 may display, on a cooking container, only cooking information selected by the user among a plurality of pieces of cooking information.

The induction heating device 2000 may receive, from the mobile device 1000, a list of cooking information to be displayed on a cooking container 1 via the server 3000.

For example, the mobile device 1000 may receive, from the server 3000, a list of cooking information to be displayed on a cooking container. Also, the mobile device 1000 may receive, from the server 3000, operating information 151 of the induction heating device 2000. In addition, the mobile device 1000 may display the operating information 151 of the induction heating device 2000. Also, the mobile device 1000 may display a user interface 153 for selecting at least one of a plurality of pieces of cooking information to be displayed on a cooking container.

Upon receiving a user input of selecting at least one of the plurality pieces of cooking information to be displayed on a cooking container through the user interface 153, the mobile device 1000 may transmit, to the server 3000, at least one selected piece of cooking information based on a user account. Also, the server 3000 may transmit the at least one selected piece of cooking information to the induction heating device 2000 stored in correspondence to the user account. The induction heating device 2000 may project only the at least one selected piece of cooking information onto the cooking container.

For example, when the mobile device 1000 receives a user input of selecting the heating level and cumulative heating time of a burner, the induction heating device 2000 may project a flame image 31 indicating the heating level of the burner and an image 113 indicating the cumulative heating time onto the cooking container 1.

According to an embodiment, the induction heating device 2000 may display a user interface for selecting at least one of a plurality of pieces of cooking information to be displayed on a cooking container, and may also directly receive a user input of selecting at least one of a plurality of pieces of cooking information to be displayed on the cooking container through the user interface.

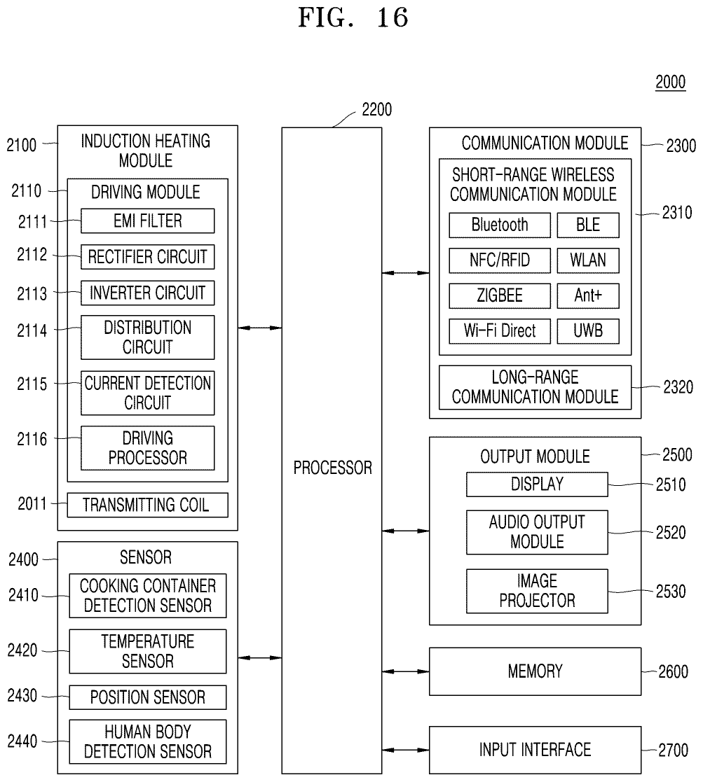

FIG. 16 shows a block diagram of an induction heating device according to an embodiment of the present disclosure.

As shown in FIG. 16, the induction heating device 2000 may include the induction heating module 2100, a sensor 2400, the processor 2200, a communication module 2300, an output module 2500, the memory 2600, and an input interface 2700. However, not all of the components shown are essential. The induction heating device 2000 may be implemented with more components than the illustrated components, or the induction heating device 2000 may be implemented with fewer components.

The induction heating module 2100 may include a driving module 2110 and a transmitting coil 2011, but is not limited thereto. The driving module 2110 may receive power from an external source and supply a current to the transmitting coil 2011 according to a driving control signal of the processor 2200. The driving module 2110 may include an electro-magnetic interference (EMI) filter 2111, a rectifier circuit 2112, an inverter circuit 2113, a distribution circuit 2114, a current sensing circuit 2115, and a driving processor 2116, but is not limited thereto.

The EMI filter 2111 may block high-frequency noise included in an alternating current power supplied from an external source and pass an alternating current voltage and alternating current of a predetermined frequency (for example, 50 Hz or 60 Hz). A fuse and relay may be provided between the EMI filter 2111 and an external source to block overcurrent. The alternating current power in which high-frequency noise is blocked by the EMI current 2111 is supplied to the rectifier circuit 2112.

The rectifier circuit 2112 may convert alternating current power into direct current power. For example, the rectifier circuit 2112 may convert an alternating current voltage of which the magnitude and polarity (positive voltage or negative voltage) change over time into a direct current voltage of which the magnitude and polarity are constant, and may convert an alternating current of which the magnitude and direction (positive current or negative current) change over time into a direct current of which the magnitude and direction are constant. The rectifier circuit 2112 may include a bridge diode. For example, the rectifier circuit 2112 may include four diodes. The bridge diode may convert an alternating current voltage of which the polarity changes over time into a positive voltage of which the polarity is constant, and may convert an alternating current of which the direction changes over time into a positive current of which the direction is constant. The rectifier circuit 2112 may include a direct current (DC) link capacitor. The DC link capacitor may convert a positive voltage of which the magnitude changes over time into a DC voltage of which the size is constant.

The inverter circuit 2113 may include a switching circuit that supplies or blocks a driving current to the transmitting coil 2011, and a resonance circuit that causes resonance with the transmitting coil 2011. The switching circuit may include a first switch and a second switch. The first switch and the second switch may be connected in series between a plus line and a minus line, which are output from the rectifier circuit 2112. The first switch and the second switch may be turned on or off according to a driving control signal of the driving processor 2116.

The inverter circuit 2113 may control a current supplied to the transmitting coil 2011. The magnitude and direction of a current flowing in the transmitting coil 2011 may change depending on the turning on/off of the first switch and the second switch included in the inverter circuit 2113. In this case, an alternating current may be supplied to the transmitting coil 2011. According to an switching operation of the first switch and the second switch, a sinusoidal alternating current is supplied to the transmitting coil 2011. In addition, as a switching cycle of the first switch and the second switch becomes longer (for example, as the switching frequency of the first switch and the second switch becomes smaller), a current supplied to the transmitting coil 2011 may increase, and the intensity of a magnetic field output by the transmitting coil 2011 (an output of the induction heating device 2000) may increase. The transmitting coil 2011 may also be referred to as a working coil in an aspect of causing a heating operation by generating a magnetic field.

When the induction heating device 2000 includes a plurality of transmitting coils 2011, the driving module 2110 may include the distribution circuit 2114. The distribution circuit 2114 may include a plurality of switches that passes or blocks current supplied to the plurality of transmitting coils 2011, and the plurality of switches may be turned on or off according to a distribution control signal of the driving processor 2116.

The current sensing circuit 2115 may include a current sensor that measures a current output by the inverter circuit 2113. The current sensor may transmit an electrical signal corresponding to a measured current value to the driving processor 2116.

The driving processor 2116 may determine a switching frequency (turn-on/turn-off frequency) of a switching circuit included in the inverter circuit 2113 based on an output intensity (power level) of the induction heating device 2000. The driving processor 2116 may generate a driving control signal for turning on/off the switching circuit according to the determined switching frequency.

The transmitting coil 2011 may generate a magnetic field for heating a cooking container. For example, when a driving current is supplied to the transmitting coil 2011, a magnetic field may be induced around the transmitting coil 2011. When a current of which the magnitude and direction change over time, that is, an alternating current, is supplied to the transmitting coil 2011, a magnetic field of which the magnitude and direction change over time may be induced around the transmitting coil 2011. A magnetic field around the transmitting coil 2011 may pass through an upper plate including tempered glass and reach a cooking container placed on the upper plate. Due to the magnetic field of which the magnitude and direction change over time, an eddy current that rotates around the magnetic field may be generated in a cooking container, and electrical resistance heat may occur in the cooking container due to the eddy current. The electrical resistance heat is the heat generated in a resistor when current flows through the resistor, which is referred to as Joule heat. The cooking container may be heated by the electrical resistance heat, and contents within the cooking container may be heated.

The processor 2200 controls the overall operation of the induction heating device 2000. The processor 2200 may control the induction heating module 2100, the communication module 2300, the sensor 2400, the output module 2500, the memory 2600, and the input interface 2700 by executing programs stored in the memory 2600.

According to an embodiment, the induction heating device 2000 may be mounted with an artificial intelligence (AI) processor. The AI processor may be manufactured in a form of a dedicated hardware chip for AI, or may also be manufactured as part of an existing general-purpose processor (for example, a central processing unit (CPU) or an application processor) or a graphics-only processor (for example, a graphics processing unit (GPU) and mounted on the induction heating device 2000.

According to an embodiment of the present disclosure, the processor 2200 may control the output module 2500 to output information that guides cooking to a user.

The communication module 2300 may include one or more components that enable communication between the induction heating device 2000 and the mobile device 1000, the hood 4000, or the server 3000. For example, the communication module 2300 may include a short-range wireless communication module 2310 and a long-range communication module 2320. The short-range wireless communication module may include a Bluetooth communication module, a Bluetooth low energy (BLE) communication module, a near-field communication module, a wireless local area network (WLAN) (Wi-Fi) communication module, a Zigbee communication module, an infrared data association (IrDA) communication module, a Wi-Fi Direct (WFD) communication module, an ultra-wideband (UWB) communication module, an Ant₊communication module, or the like, but is not limited thereto. The long-range communication module 2320 transmits and receives wireless signals to/from at least one of a base station, an external terminal, and the server 3000 on a mobile communication network. Herein, wireless signals may include various forms of data according to voice call signals, video call signals, or text/multimedia message transmission and reception. The long-range communication module 2320 may include a third generation (3G) module, a fourth generation (4G) module, a long-term evolution (LTE) module, a fifth generation (5G) module, a sixth generation (6G) module, a narrow band Internet of Things (NB-IoT) module, an LTE-M module, or the like, but is not limited thereto.

The sensor 2400 may include a cooking container detection sensor 2410, a temperature sensor 2420, a position sensor 2430, and a human body detection sensor 2440, but is not limited thereto.

The cooking container detection sensor 2410 may be a sensor detecting that a cooking container is placed on an upper plate of the induction heating device 2000. For example, the cooking container detection sensor 2410 may be implemented as a current sensor, but is not limited thereto. The cooking container detection sensor 2410 may also be implemented as at least one of a proximity sensor, a touch sensor, a weight sensor, a temperature sensor, a light sensor, and a magnetic sensor.

The temperature sensor 2420 may detect the temperature of a cooking container placed on an upper plate, the temperature of the upper plate of the induction heating device 2000, or the temperature of contents within the cooking container. The cooking container may be heated by the transmitting coil 2011 and may overheat depending on the material thereof. Accordingly, the induction heating device 2000 may detect the temperature of the cooking container placed on the upper plate or the temperature of the upper plate of the induction heating device 2000 and may block an operation of the transmitting coil 2011 when the cooking container is overheated. The temperature sensor 2420 may be installed near the transmitting coil 2011. For example, the temperature sensor 2420 may be positioned exactly at the center of the transmitting coil 2011.

According to an embodiment of the present disclosure, the temperature sensor 2420 may a thermistor of which an electric resistance value changes depending on temperature. For example, the temperature sensor 2420 may be a negative temperature coefficient (NTC) temperature sensor, but is not limited thereto. The temperature sensor 2420 may also be a positive temperature coefficient (PTC) temperature sensor.

The induction heating device 2000 may detect a position of the user relative to the induction heating device 2000 based on a sensor value of the position sensor 2430. The position sensor 2430 may include an ultrasonic sensor and a camera sensor, but is not limited thereto.

The human body detection sensor 2440 may detect whether the user is near the induction heating device 2000. The human body detection sensor 2440 may include a passive infrared (PIR) sensor, an ultrasonic motion sensor, and a laser motion sensor, but is not limited thereto.

The output module 2500 is configured to output an audio signal or a video signal, and may include a display 2510, an audio output module 2520, an image projector 2530, or the like.

When the display 2510 and a touchpad are configured as a touch screen in a layered structure, the display 2510 may also be used as an input interface in addition to an output interface. The display 2510 may include at least one of an LCD, a thin-film transistor-LCD, an LED, an organic LED, a flexible display, a three-dimensional (3D) display, and an electrophoretic display. Also, the induction heating device 2000 may also include two or more displays 2510 according to the implementation form of the induction heating device 2000.

According to an embodiment of the present disclosure, the display 2510 may also output information about a burner performing heating, information about a heating level of a burner, recipe information, cumulative heating time information of a burner, information about a cooking mode of a burner, information about a cooking area being used of a burner, information about the temperature of contents within a cooking container, information that guides cooking, or the like.

The audio output module 2520 may output audio data received from the communication module 2300 or stored in the memory 2600. Also, the audio output module 2520 may output an audio signal related to a function performed by the induction heating device 2000. The audio output module 2520 may include a speaker, a buzzer, or the like.

The image projector 2530 may project an image onto a cooking container. The image projector 2530 may include an LCD projector, a DLP projector, an LED projector, an LCOS projector, and a laser projector, and is not limited thereto. For example, the image projector 2530 may be in a form of a convex lens attached to a plurality of LEDs having different colors.

The input interface 2700 is configured to receive an input from the user. The input interface 2700 may include at least one of touchpads (a contact-type electrostatic capacitance type, a pressure-type resistive film type, an infrared detection type, a surface ultrasonic conduction type, an integral tension measurement type, a piezo effect type, or the like), but is not limited thereto.

The induction heating device 2000 may obtain the speech intention of the user by interpreting a converted text by using a natural language understanding (NLU) model. Herein, an automatic speech recognition (ASR) model or an NLU model may be an AI model. The AI model may be processed by an AI-dedicated processor designed with a hardware structure specialized for processing AI models. The AI model may be created through training. Herein, being created through training means that a basic AI model is trained by a training algorithm by using multiple pieces of training data, thereby creating a predefined operation rule or an AI model to perform desired characteristics (or purposes). The AI model may be configured with a plurality of neural network layers. Each of the plurality of neural network layers has a plurality of weight values, and performs a neural network operation through operations between operation results of previous layers and the plurality of weight values.

Linguistic understanding is a technology that recognizes and applies/processes human languages/characters, and includes natural language processing, machine translation, dialog systems, question answering, speech recognition/synthesis, or the like.

The memory 2600 may also store a program configured to process and control the processor 2200, or may store input/output data. The memory 2600 may also store an AI model.

The memory 2600 may include at least one type of storage medium from among a flash memory type, a hard disk type, a multimedia card micro type, a card type memory (for example, secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, and an optical disk. In addition, the induction heating device 2000 may also operate a web storage or a cloud server 3000 that performs a storage function on the Internet.

At least one processor 2200 may project, through the image projector 2530, a first cooking information image corresponding to a front burner onto a first cooking container placed on the front burner among a plurality of burners.

At least one processor 2200 may detect that a second cooking container is placed on a rear burner corresponding to the front burner through the cooking container detection sensor 2410.

At least one processor 2200 may receive, through the input interface 2700, a user input of inductively heating the second cooking container placed on the rear burner by the induction heating module 2100.

At least one processor 2200 may detect that the second cooking container is placed on the rear burner, and may project, onto the first cooking container placed on the front burner through the image projector 2530, the first cooking information image corresponding to the front burner together with a second cooking information image corresponding to the rear burner, based on reception of the user input of inductively heating the second cooking container.

The induction heating device 2000 may include a flex burner capable of inductive heating a plurality of cooking containers regardless of positions where the cooking containers are placed.

At least one processor 2200 may identify coordinate values of an area where at least one cooking container is placed among an area of the flex burner based on at least one of current values and temperatures detected at a plurality of coordinate points within the area of the flex burner, identify whether the at least one cooking container is placed front-to-back based on the identified coordinate values, and project, onto a front cooking container placed in front, a cooking information image corresponding to the front cooking container together with a cooking information image corresponding to a cooking container placed behind, based on the at least one cooking container being placed front-to-back.

At least one processor 2200 may identify the position of the user through the position sensor 2430. At least one processor 2200 may move the positions of the first cooking information image and the second cooking information image, which are displayed on the first cooking container, according to the identified position of the user.

At least one processor 2200 may identify whether the user is positioned within a reference distance from the induction heating device 2000 through the human body detection sensor 2440.

Also, at least one processor 2200 may project the first cooking information image onto an upper surface of the first cooking container placed on the front burner and the second cooking information image onto an upper surface of the second cooking container placed on the rear burner by controlling a laser of a hood device positioned above the induction heating device 2000 based on the position of the user being within the reference distance from the induction heating device 2000.

At least one processor 2200 may determine image data for the first cooking information image indicating cooking information of the front burner. At least one processor 2200 may input the determined image data into the image projector 2530, and thus the first cooking information image may be projected onto the image projector 2530.

In this case, the image data may include at least one of image data indicating numbers and image data indicating characters.

At least one processor 2200 may obtain at least one piece of cooking information selected by the user from among a plurality of pieces of cooking information.

Also, at least one processor 2200 may project the first cooking information image indicating at least one selected piece of cooking information from among the plurality pieces of cooking information related to the front burner onto the first cooking container placed on the front burner.

The induction heating device 2000 may include a burner that is not equipped with the image projector 2530.

At least one processor 2200 may project, onto the first cooking container placed on the front burner through the image projector 2530, a cooking information image corresponding to a burner that is not equipped with a dedicated image projector 2530.

A machine-readable storage medium may be provided in a form of non-transitory storage medium. Herein, the ‘non-transitory storage medium’ means a tangible device that does not include signals (for example: electromagnetic waves), and this term does not distinguish between cases where data is stored semi-permanently or temporarily on a storage medium. For example, the ‘non-transitory storage medium’ may include a buffer in which data is temporarily stored.

According to an embodiment, methods according to various embodiments disclosed in the present document may be provided as included in a computer program product. The computer program product may be traded between sellers and buyers as commodities. The computer program product may be distributed in a form of a machine-readable storage medium (for example: compact disc ROM (CD-ROM)), or may be distributed online (for example: download or upload) through an application store or directly between two user devices (for example: smart phones). In the case of online distribution, at least a part of the computer program product (for example: a downloadable application) may be at least temporarily stored or temporarily created in a machine-readable storage medium, such as the memory of a server of a manufacturer, a server of an application store, or an intermediary server.

1. An induction heating device comprising:
an induction heating module;
at least one image projector configured to project at least one image;
at least one memory to store one or more instructions; and
at least one processor is configured to execute the one or more instructions stored in the at least one memory to:
control the image projector to project, onto a first cooking container placed on a first burner among a plurality of burners, a first image set corresponding to the first burner, and
control the image projector to project, onto the first cooking container placed on the first burner, a second image set corresponding to a second burner together with the first image set, based on a second cooking container being placed on the second burner among the plurality of burners and inductively heated by the induction heating module.

2. The induction heating device of claim 1, wherein the first image set and the second image set are distinguished from each other based on at least one of color, size, position, changing pattern or shape.

3. The induction heating device of claim 1, further comprising a flex burner which comprises at least one burner to inductively heat at least one cooking container regardless of positions where the at least one cooking container is placed,
the at least one processor is configured to execute the one or more instructions stored in the at least one memory to:
identify coordinate values of where at least one cooking container is placed in an area of the flex burner based on at least one of current values or temperatures detected at a plurality of coordinate points within the area of the flex burner, and
identify a burner among the plurality of burners in which the at least one cooking container is placed based on the coordinate values.

4. The induction heating device of claim 1, further comprising:
a position sensor,
wherein the at least one processor is configured to execute the one or more instructions stored in the at least one memory to identify a position of a user based on values detected by the position sensor and move positions of the first image set and the second image set, which are projected on the first cooking container, according to the identified position of the user.

5. The induction heating device of claim 1, further comprising:
a communication module to communicate with at least one other device,
wherein the at least one processor is configured to execute the one or more instructions stored in the at least one memory to identify a position of a user based on information obtained from the at least one other device and move positions of the first image set and the second image set, which are projected on the first cooking container, according to the identified position of the user.

6. The induction heating device of claim 1, further comprising:
a sensor,
wherein the at least one processor is configured to execute the one or more instructions stored in the at least one memory to:
identify whether a user is positioned within a reference distance from the induction heating device based on values detected by the sensor,
control a laser of a hood device positioned above the induction heating device to project the first image set onto an upper surface of the first cooking container and the second image set onto an upper surface of the second cooking container, based on the position of the user being within the reference distance from the induction heating device.

7. The induction heating device of claim 1, further comprising:
a communication module to communicate with at least one other device,
wherein the at least one processor is configured to execute the one or more instructions stored in the at least one memory to:
identify whether a user is positioned within a reference distance from the induction heating device based on information obtained from the at least one other device,
control a laser of a hood device positioned above the induction heating device to project the first image set onto an upper surface of the first cooking container and the second image set onto an upper surface of the second cooking container, based on the position of the user being within the reference distance from the induction heating device.

8. The induction heating device of claim 1, wherein the first image set comprises at least one of an image indicating a current temperature of the first burner, an image indicating a cumulative cooking time of the first burner, an image indicating a heating level of the first burner, or an image indicating recipe information corresponding to the first burner.

9. The induction heating device of claim 1, wherein the at least one processor is configured to execute the one or more instructions stored in the at least one memory to:
project an image corresponding to a user selection as the first image set,

10. The induction heating device claim 9, further comprising communication module to communicate with at least one other device,
wherein the at least one processor is configured to execute the one or more instructions stored in the at least one memory to:
obtain the user selection through the communication module, wherein the user selection being based on a user account.

11. A method by which an induction heating device displays cooking information, the method comprising:
projecting, onto a first cooking container placed on a first burner among a plurality of burners, a first image set corresponding to the first burner; and
projecting, onto the first cooking container placed on the first burner, a second image set corresponding to a second burner together with the first image set, based on a second cooking container being placed on the second burner among the plurality of burners and inductively heated.

12. The method of claim 11, wherein the first image set and the second image set are distinguished from each other based on at least one of color, size, position, changing pattern or shape.

13. The method of claim 11, wherein the plurality of burners comprise a flex burner which comprises at least one burner to inductively heat at least one cooking container regardless of positions where the at least one cooking container is placed,
the method further comprises:
identifying coordinate values of where at least one cooking container is placed in an area of the flex burner based on at least one of current values or temperatures detected at a plurality of coordinate points within the area of the flex burner, and
identifying a burner among the plurality of burners in which the at least one cooking container is placed based on the coordinate values.

14. The method of claim 11, further comprising:
identifying a position of a user; and
moving positions of the first image set and the second image set, which are projected on the first cooking container, according to the identified position of the user.

15. The method of claim 11, further comprising:
identifying a position of a user based on information obtained from at least one other device; and
moving positions of the first image set and the second image set, which are projected on the first cooking container, according to the identified position of the user.

16. The method of claim 11, further comprising:
identifying whether a user is positioned within a reference distance from the induction heating device based on values detected by a sensor,
controlling a laser of a hood device positioned above the induction heating device to project the first image set onto an upper surface of the first cooking container and the second image set onto an upper surface of the second cooking container, based on the position of the user being within the reference distance from the induction heating device.

17. The method of claim 11, further comprising:
identifying whether a user is positioned within a reference distance from the induction heating device based on information obtained from at least one other device,
controlling a laser of a hood device positioned above the induction heating device to project the first image set onto an upper surface of the first cooking container and the second image set onto an upper surface of the second cooking container, based on the position of the user being within the reference distance from the induction heating device.

18. The method of claim 11, wherein the first image set comprises at least one of an image indicating a current temperature of the first burner, an image indicating a cumulative cooking time of the first burner, an image indicating a heating level of the first burner, or an image indicating recipe information corresponding to the first burner.

19. The method of claim 11, further comprising:
projecting an image corresponding to a user selection as the first image set.

20. The method of claim 19, further comprising:
obtaining the user selection through a communication module, wherein the user selection being based on a user account.
